(19) United States
(12) Patent Application Publication
(10) Pub. No.: US 2022/0258598 A1
(43) Pub. Date: Aug. 18, 2022

(54) DEVICE FOR FASTENING A COMPONENT TO A FUEL TANK

(71) Applicant: Plastic Omnium Advanced Innovation and Research, Bruxelles (BE)

(72) Inventors: Jean-Francois COING, Bruxelles (BE); Wilfried LEMASSON, Bruxelles (BE)

(73) Assignee: Plastic Omnium Advanced Innovation and Research, Bruxelles (BE)

(21) Appl. No.: 17/626,920

(22) PCT Filed: Jul. 20, 2020
(86) PCT No.: PCT/EP2020/070434

§ 371 Date: Jan. 13, 2022

(30) Foreign Application Priority Data
Jul. 19, 2019 (FR) FR1908206

(51) Int. Cl. B60K 15/03; B29C 65/00

(52) U.S. Cl. CPC B60K 15/03177; B60K 2015/03453; B60K 2015/03493; B29C 66/712

(57) ABSTRACT

The invention relates to a device (10) for fastening a component (1) to a wall (101) of a fuel tank (100). According to the invention, such a device (10) for fastening a component (1) to a wall (101) of a fuel tank (100) comprises an anchoring element (3) that is able to be secured to said wall (101) of the fuel tank (100); a connecting element (2) comprising a first end (20) and a second end (21); a first means (4) for connecting said first end (20) to said anchoring element (3) and a second means (5) for connecting said second end (21) to said component (1).

The invention relates to a device for fastening a component to a wall of a fuel tank, as well as to a fuel tank comprising said device for fastening a component. More particularly, the invention relates to a method of manufacturing a fuel tank comprising said device for fastening a component to a wall of a fuel tank.

To this end, fuel tanks of various types must generally meet the standards of impermeability and permeability depending on the type of use for which they are designed and the environmental requirements they must meet. In Europe and in the rest of the world, we are currently witnessing a considerable tightening of the requirements for limiting the spread of pollutants in the environment. Fuel tank design is therefore rapidly evolving toward techniques capable of better guaranteeing impermeability and environmental safety under varying usage conditions.

Fuel tanks generally comprise a barrier layer to fuels, made of material that is impermeable to the latter, generally a resin, such as “EVOH” for ethylene vinyl alcohol. EVOH is a partially hydrolyzed ethylene vinyl acetate copolymer. In multilayer fuel tanks, the fuel-impermeable layer is generally an intermediate layer interposed between two fuel-permeable layers, made, for example, of a thermoplastic material such as HDPE for high-density polyethylene.

A device for fastening a component can be used in particular in a fuel tank. Thus, the components are generally molded by separate molding methods and must be welded to the main body of the tank. In particular, these components must not only be welded to the main body of the tank with adequate mechanical strength, but also without compromising the fuel-impermeable barrier property of a fuel tank.

Consequently, the fuel tanks located in particular on board a vehicle are connected to other components, generally impermeable to fuel, requiring the presence of several openings on the wall of the tank around which the components are fastened. These openings, which create discontinuities in the barrier layer of the wall of a tank, represent a high risk of fuel leakage or permeation, because the component fastening device cannot be in contact with the fuel-impermeable layer of the wall of the tank to form a sealed volume.

Indeed, the precise position of the fuel-impermeable layer of the tank wall is unknown and inserting the device for fastening a component too deeply into the wall of a tank increases the risk of perforating the fuel-impermeable layer. The distance from the impermeable layer of the component to the impermeable layer of the tank wall depends on the total thickness of the tank wall, the distribution of the layer thickness of the tank wall and the stretching of the wall in the welding zone inherent in the blow molding method, if such a method is used to manufacture the tank wall.

To control fuel leakage, it is necessary to precisely know the fuel leakage paths around the opening defined by the space existing between the device for fastening a component to a wall of a fuel tank and the fuel-impermeable layer of the wall of a fuel tank.

However, since the precise position of the fuel-impermeable layer in the thickness of the tank wall is unknown, these permeation paths are not predetermined.

To be able to eliminate the discontinuities in the barrier layer of the wall of a fuel tank that could be at the origin of the fuel permeation, as well as to reinforce the mechanical strength of a device for fastening to a wall of a fuel tank, various solutions have been proposed in the state of the art, in particular by;

Document US 2012/0138210 A1 discloses a method of welding a component to a plastic fuel tank comprising a component with a fuel barrier layer, said fuel barrier layer of said component approaching the fuel barrier layer of said plastic tank during said method of welding a component to a plastic fuel tank for the purpose of leading to better fuel barrier performance of the assembly, said assembly being composed of said component and said plastic fuel tank. Such an assembly has the disadvantages of having an additional outer layer on the tank, in order to allow said component to be welded to a plastic fuel tank, since the two elements of said assembly are incompatible. As well as presenting, on the weldable component, an additional fuel barrier layer, such an assembly having a gripping surface, said gripping surface being obtained during a welding method by simple juxtaposition of said elements, therefore resulting in a decreased mechanical strength.

Document EP 3124308 B1 discloses a fuel tank comprising a component welded to a fuel tank and an insert directly inserted into the wall of a fuel tank by overmolding; said insert is fully inserted into the outer wall of a fuel tank and has a polyamide or polyphthalamide core surrounded by an outer layer of modified high-density polyethylene. Such a component poses the problem of fastening the welded component due to the chemical compatibility of the welded component with a fuel tank. Indeed, the component must necessarily be chemically compatible with a fuel tank in order to obtain a desired mechanical strength to avoid any unwanted pullout of said component. In addition, the chemical compatibility of the component necessary for fastening thereof to a fuel tank induces fuel permeability of said fuel tank. Such a component therefore has the disadvantage of requiring an additional fuel-impermeable layer affixed to the inner surface of the component. Consequently, the assembly, composed of said insert and of said component, has several leakage routes for the fuels from the tank, located in particular between said insert and said additional fuel-impermeable layer of the component. Thus, to avoid excessive permeability of the component, document EP 3124308 B1 must insert said insert completely into the wall of a tank. As a result, additional parts and steps are required in carrying out this invention.

The object of the invention is in particular to overcome these drawbacks of the prior art.

More precisely, an objective of the invention, in at least one of its embodiments, is to provide a device for fastening a component to a wall of a fuel tank requiring a reduced number of elements, namely a fastening device and at least one component welded to said device, the nature of which is incompatible with the wall of a fuel tank.

The invention, in at least one of its embodiments, further aims to provide a device for fastening a component to a wall of a fuel tank having increased mechanical strength and improved sealing around an opening on the wall of a fuel tank, in particular by controlling the existing fuel permeation and leakage routes.

In addition, the invention also aims, in one of its embodiments, to provide a fuel tank comprising a device for fastening a component to a wall of a fuel tank.

Another object of the invention, in at least one of its embodiments, is to implement a method for producing a device for fastening a component to a wall of a fuel tank.

According to a particular embodiment, the invention relates to a device for fastening a component to a fuel tank.

According to the invention, such a device for fastening a component to a wall of a fuel tank comprising a thickness comprises an anchoring element capable of being secured to said wall of the fuel tank and of penetrating at least partially into said thickness; a connecting element comprising a first end and a second end; a first means for connecting said first end to said anchoring element, and a second means for connecting said second end to said component.

The general principle of the invention is based on optimizing the mechanical strength between said device for fastening a component and said wall of a fuel tank, while keeping a low fuel permeability of a fuel tank, without using gaskets. In addition, the invention makes it possible to form an interface making the fastening of incompatible components with a wall of a fuel tank. This latter principle therefore allows any type of component to be able to be fastened to a wall of a fuel tank using any type of fastening technique. The invention is also based on optimizing the method of producing the device for a component at a wall of a fuel tank by reducing the number of steps in the method for obtaining the device for fastening a component to a wall of a fuel tank, and thus reducing the number results in decreasing the production cost of said device for fastening a component to a wall of a fuel tank.

Thus, the invention is based on a completely new and inventive approach to producing a device for fastening a component to a wall of a fuel tank comprising an anchoring element capable of being secured to a wall of a fuel tank, a connecting element comprising a first end and a second end, a first means for connecting said first end to said anchoring element and a second means for connecting said second end to said component.

The expression “component” is understood to denote the various elements that can be fastened to said device for fastening a component to a wall of a fuel tank, such as a filler neck, a ventilation valve, a valve or another shutter plate; these components are given by way of illustrative and non-limiting example.

The expression “anchoring element capable of being secured to said wall of the fuel tank” is understood to denote the fact that an anchoring element has a face oriented toward the wall of a fuel tank and that said anchoring element is at least partially anchored in the wall of a fuel tank, preferably totally anchored in the wall of a fuel tank.

The expression “connecting element comprising a first end and a second end” is understood to denote the fact that a connecting element forms the interface between an anchoring element and a component. In other words, this element can be connected with the anchoring element by a first connection means located on a first end and connected with a component by a second connection means located on a second end.

The expression “a first end” is understood to denote the fact that the part of the connecting element of the device for fastening a component to a wall of a fuel tank ends in the vicinity of the anchoring element of the device for fastening a component to a wall of a fuel tank.

The expression “a second end” is understood to denote the fact that the part of the connecting element of the device for fastening a component to a wall of a fuel tank ends in the vicinity of said component.

The expression “components not compatible with a wall of a fuel tank” is understood to denote the fact that these two elements, namely components and a wall of a fuel tank, are incompatible. In other words, these elements cannot be connected to each other because said elements are each composed of materials having poor miscibility with one another.

The expression “said elements are each composed of materials having poor miscibility with one another” is understood to denote the fact that these elements cannot mix and form a heterogeneous mixture. As a result, these elements cannot be linked together.

According to the invention, such a device for fastening a component to a wall of a fuel tank, comprising at least one anchoring element capable of being secured to a wall of a fuel tank; at least one connecting element capable of ensuring the connection of said component to said anchoring element; the anchoring element comprising a first connection means capable of connecting said connecting element to said anchoring element; the connecting element comprising a second connection means capable of connecting said component to said connecting element.

Thus, such a device for fastening a component to a wall of a fuel tank makes it possible to obtain increased mechanical strength between said device for fastening a component and said wall of a fuel tank without using gaskets or additional fuel-impermeable tape. Therefore, the number of elements forming the invention is decreased, thereby reducing the number of steps in the method of manufacturing said device for fastening a component to a wall of a fuel tank, involving a decrease in the cost of producing said device for fastening a component to a wall of a fuel tank.

According to the invention, such a device for fastening a component to a wall of a fuel tank comprises a connecting element comprising a third connection means capable of being connected to the first connection means of said anchoring element.

Thus, such a device for fastening a component to a wall of a fuel tank makes it possible to obtain a connection between different connection means, allowing a wider choice of possibilities in producing the connection between the connecting element and the anchoring element of said device for fastening a component to a wall of a fuel tank, while optimizing the mechanical strength

The expression “third connection means” is understood to denote the connection reciprocity with the first connection means. In other words, the first connection means designates the connection between the connecting element and the anchoring element, and the third connection means designates the connection between the anchoring element and the connecting element.

Advantageously, the device for fastening a component to a wall of a fuel tank according to the invention is such that the anchoring element is a square, polygonal, rectangular or cylindrical ring; according to one preferred embodiment, the anchoring element has a cylindrical shape in which the diameter is smaller than its height.

Thus, the anchoring element of the device for fastening a component to a wall of a fuel tank, forming a square, polygonal, rectangular or cylindrical ring, in a preferred embodiment a cylindrical ring, allows the passage of a fluid in its center, such as air or fuel in the directions of flow and backflow. Since the cylindrical ring is more easily produced, said cylindrical ring thus reduces the associated production costs. The associated production costs are reduced by the possibility of simultaneously carrying out a drilling step and an overmolding step. In addition, the cylindrical ring of the device for fastening a component to a wall of a fuel tank allows a reinforced seal, as well as easier assembly during the production of said device for fastening a component to a wall of a fuel tank.

According to a preferred embodiment, the device for fastening a component to a wall of a fuel tank according to the invention is such that said first connection means is chosen from connections of the male and female type, such as hooping, riveting, threading, screwing, clipping, dovetail assembly, straight shank assembly, relief or undercut assembly, and connections such as welding, gluing, mechanical assembly with seal, overmolding, preferably, said connection means is an overmolding, more preferably an overmolding by bi-injection.

Thus, these connection techniques allow an increase in the mechanical strength between two elements made of compatible or non-compatible materials, while maintaining tightness of the entire fuel tank.

The term “connections of the male and female type” is understood to denote connections composed of two distinct parts, whereof the ends of these two distinct parts define on the one hand, the protuberances of the male part, intended on the other hand to be inserted into the corresponding housings of the female part.

According to a preferred embodiment, the device for fastening a component to a wall of a fuel tank according to the invention is such that said first connection means and said third connection means are able to be connected, said connection is chosen from connections of the male and female type, such as hooping, riveting, threading, screwing, clipping, dovetail assembly, straight shank assembly, relief or undercut assembly, and connections such as welding, gluing, mechanical assembly with seal, overmolding, preferably, said connection means is an overmolding, more preferably an overmolding by bi-injection.

Thus, these connection techniques allow an increase in the mechanical strength between two elements made of compatible or non-compatible materials, while maintaining tightness of the entire fuel tank.

According to a preferred embodiment, the device for fastening a component to a wall of a fuel tank according to the invention is fastened by overmolding. In other words, said device for fastening a component has a surface that lies in front of the fuel-impermeable layer of the wall. The position of said elements, constituting said device for fastening a component to a wall of a fuel tank, is thus predetermined. Therefore, the fuel penetration path is controlled. In addition, the distance between said fastening device and the fuel-impermeable layer is controlled during the overmolding process.

Thus, the device for fastening a component to a wall of a fuel tank is made in one piece composed of two elements, which reduces costs and simplifies the positioning and the maintenance in the overmolding mold.

According to a preferred embodiment, the device for fastening a component to a wall of a fuel tank according to the invention is such that said second connection means is chosen from connections of the male and female type, such as hooping, riveting, threading, screwing, clipping, dovetail assembly, straight shank assembly, relief or undercut assembly, and connections such as welding, gluing, mechanical assembly with seal, overmolding, preferably, said connection means is a weld.

Thus, these connection techniques allow an increase in the mechanical strength between two elements made of compatible or non-compatible materials, while maintaining tightness of the entire fuel tank.

According to a preferred embodiment, the device for fastening a component to a wall of a fuel tank according to the invention is such that said anchoring element comprises a plastic material, said plastic material being chosen from among plastic materials with a polyolefin base, preferably, said plastic material is polyethylene, more preferably, said plastic material is maleic anhydride grafted polyethylene.

Thus, the anchoring element can be at least partially anchored in the wall of a fuel tank, preferably completely anchored in the wall of a fuel tank, allowing increased mechanical strength between said device for fastening a component and said wall of a fuel tank. Indeed, the anchoring element is based on a plastic material compatible with the wall of a fuel tank. Namely in the invention, the material making up the anchoring element is maleic anhydride grafted polyethylene and the material making up the wall of a fuel tank is high-density polyethylene.

The expression “polyolefin-based” is understood to denote the fact that the anchoring element comprises at least 50% by weight of polyolefin, preferably 75% by weight of polyolefin, more preferably 90% by weight of polyolefin, most preferably 99% by weight of polyolefin.

According to a preferred embodiment, the device for fastening a component to a fuel tank wall according to the invention is such that said connecting element comprises a plastic material, said plastic material being chosen from plastic materials based on polyoxymethylene, polyphenylene sulfide, polyamide, polyphthalamide, polyetheretherketone, polyamide imide, polyaryletherketone, polyketone or polyolefin; preferably, said plastic material is polyamide.

Thus, the connecting element can be linked with any type of component by a different connection technique, since said connecting element is based on a plastic material compatible with a component.

The expression “based on polyamide” is understood to denote the fact that the anchoring element comprises at least 50% by weight of polyamide, preferably 75% by weight of polyamide, more preferably 90% by weight of polyamide, most preferably 99% by weight of polyamide.

According to a preferred embodiment, the device for fastening a component to a fuel tank wall according to the invention is such that said connecting element comprises a plastic material, said plastic material being chosen from plastic materials based on polyoxymethylene, polyphenylene sulfide, polyamide, polyphthalamide, polyetheretherketone, polyamide imide, polyaryletherketone, polyketone or polyolefin; preferably, said plastic material is polyphthalamide.

Thus, the connecting element can be linked with any type of component by a different connection technique, since said connecting element is based on a plastic material compatible with a component.

The expression “based on polyphthalamide” is understood to denote the fact that the anchoring element comprises at least 50% by weight of polyphthalamide, preferably 75% by weight of polyphthalamide, more preferably 90% by weight of polyphthalamide, most preferably 99% by weight of polyphthalamide.

According to a preferred embodiment, the device for fastening a component to a wall of a fuel tank according to the invention is such that said anchoring element comprises at least one part having dimensions greater than the dimensions of said first connection means of said device for fastening a component to a fuel tank, said part of said anchoring element being positioned opposite said first connection means of the device for fastening a component to a wall of a fuel tank.

Thus, the device for fastening a component to a wall of a fuel tank makes it possible to obtain increased mechanical strength through a specific shape guaranteeing improved mechanical anchoring.

The expression “said part of said anchoring element being positioned opposite said first connection means of the device for fastening a component to a wall of a fuel tank” is understood to denote the lower part of the anchoring element of the device for fastening a component to a wall of a fuel tank.

The concepts of lower and upper are defined with respect to the final location of the device for fastening a component to a wall of a fuel tank and are defined by taking as reference the wall of a fuel tank, to which said device for fastening a component is fastened. A lower edge of an element is closer to the wall of a fuel tank than an upper edge of the same element.

According to a preferred embodiment, the device for fastening a component to a wall of a fuel tank according to the invention is such that said anchoring element comprises a part capable of being fused to said wall of said fuel tank.

Thus, fusing the anchoring element to a wall of a fuel tank makes it possible to obtain an increased mechanical strength by reinforcing the cohesion of two elements, the two elements being said anchoring element of the device for fastening a component to a wall of a fuel tank and said wall of a fuel tank.

“A wall able to be fused” denotes a plastic material that is “chemically compatible” with another plastic material means that the plastic materials each comprise chemical species that can be welded together without requiring additional material. In other words, chemically compatible plastic materials are capable of bonding closely together by melting, and in particular of producing a molecular entanglement of their respective polymer chains. Welding the two plastic materials means bringing the two plastic materials into contact in such a way that the self-adhesion phenomenon occurs at the point of contact. The self-adhesion phenomenon occurs when heat is applied to the point of contact. An operation for welding two materials under the action of heat is called thermowelding. In the following, “welding” is used synonymously with “thermowelding.”

“Molecular entanglement of polymer chains” of one plastic material and another plastic material means two plastic materials pressed together in such a way that a self-adhesion phenomenon occurs. Self-adhesion of this kind is the phenomenon describing the intermolecular diffusion and entanglement of molecular chains across a polymer interface, resulting in a strong bond. Unlike adhesion, which concerns surface energy (or secondary chemical bonds between two materials that are either similar or not similar), self-adhesion concerns the entanglement of molecular chains and secondary bonds for polymer chains of similar materials, i.e. chemically compatible materials. Under ideal conditions, the diffusion is complete when the interface between the two polymer materials is no longer discernible from the bulk of each of the two polymer materials. For example, in the case of two thermoplastic polymer materials, once thermoplastic polymer-thermoplastic polymer contact is achieved at the interface, intermolecular diffusion and entanglement is required to complete the process and produce a good weld. An autohesion phenomenon of this kind is described, for example, in the publication “Plastics and Composites Welding Handbook,” ISBN 1-5990-313-1, page 23.

According to an alternative embodiment, the device for fastening a component to a wall of a fuel tank according to the invention is such that said part having dimensions greater than the dimensions of said first connection means of said device for fastening a component to a fuel tank is capable of being fused to the wall of a fuel tank, preferably on at least a fraction of said part, more preferably on a fraction formed by at least one end of a part of the anchoring element having dimensions greater than the dimensions of said first connection means of said device for fastening a component to a fuel tank, said part capable of being fused being inscribed in a plane parallel to the impermeable layer of said wall of a fuel tank.

Thus, the fusion of the anchoring element to a wall of a fuel tank and the specific form of anchoring provide an optimized mechanical strength between said device for fastening a component to a wall of a fuel tank and said wall of a fuel tank. Indeed, this alternative embodiment allows greater mechanical strength between said device for fastening a component to a wall of a fuel tank and said wall of a fuel tank because this mechanical strength is no longer obtained by just one method, but by the combination of two different methods.

The expression “being inscribed in a plane parallel to the impermeable layer of said wall of a fuel tank” is understood to denote the fact that the part having dimensions greater than the dimensions of said first connection means of said device for fastening a component to a fuel tank, adapted to be fused at its ends to the wall of a fuel tank, is a part defining a segment in the anchoring element that is parallel to the fuel-impermeable layer of the wall of the fuel tank.

According to the invention, the device for fastening a component to a wall of a fuel tank is such that said wall of said fuel tank has a thickness and in that said anchoring element penetrates at least partly into said thickness.

Thus, this penetration allows increased mechanical strength between the device for fastening a component to a wall of a fuel tank and a wall of a tank, while maintaining low permeability of a fuel tank.

According to the invention, such a device for fastening a component to a wall of a fuel tank comprising an anchoring element at least partially anchored in the wall of a fuel tank, the anchoring element is preferably fully anchored in the wall of a fuel tank.

Thus, this anchoring allows increased mechanical strength between the device for fastening a component to a wall of a fuel tank and a wall of a tank, while maintaining low permeability of a fuel tank.

According to a preferred embodiment, the device for fastening a component to a wall of a fuel tank according to the invention is such that said wall of said fuel tank has a fuel-impermeable layer and in that said anchoring element is not in contact with said layer. Therefore, the device for fastening a component to a wall of a fuel tank according to the invention is such that the impermeable layer of the tank wall and said fastening device are spaced apart. In a preferred embodiment, the shortest distance between the fuel-impermeable layer of the fuel tank wall and the device for fastening a component to a wall of a fuel tank is a few micrometers.

Thus, having the impermeable layer of the tank wall spaced apart from the device for fastening a component to a wall of a fuel tank allows the integrity of the tank to be maintained with respect to its impermeability. Indeed, maintaining a distance between the impermeable layer of the wall of a fuel tank and the device for fastening a component to a wall of a fuel tank allows the device for fastening a component to a wall of a fuel tank to penetrate inside the fuel tank wall without risking puncturing the impermeable layer of the fuel tank wall. Consequently, the possible fuel leakage routes are reduced.

Another object of the invention is to provide a fuel tank comprising a device for fastening a component to a wall of a fuel tank according to the invention.

According to a preferred embodiment, the anchoring element is secured to said wall of the fuel tank without passing through it.

According to a preferred embodiment, said wall of the fuel tank comprises a layer made of a polyolefin-based material into which the anchoring element penetrates.

According to a preferred embodiment, said wall of the fuel tank comprises a fuel barrier layer, for example made from a material based on ethylene vinyl alcohol, located under the layer made from a material based on polyolefin.

The expression “said wall of the fuel tank comprises a fuel barrier layer located under the layer made from a material based on polyolefin” is understood to mean that the fuel barrier layer is closer to the internal volume of the fuel tank than the layer made of a polyolefin-based material. It is thus understood that the anchoring element does not come into contact with the fuel barrier layer. The fastening device therefore makes it possible not to compromise the tightness of the tank provided by the fuel barrier layer.

The invention also relates to a method of manufacturing a fuel tank comprising at least the following steps:
Providing a wall of a fuel tank having a thickness;
Securing said anchoring element to said wall by causing it to penetrate at least partially into said thickness.

### LIST OF FIGURES

Other features and advantages of the invention will become clear on reading the following description of a preferred embodiment, given merely as an illustrative and non-limiting example, and the appended drawings, in which:

FIG. 1a shows a device for fastening a component to a wall of a fuel tank according to the invention.

FIG. 1b shows an enlargement of a device for fastening a component to a wall of a fuel tank according to the invention.

FIG. 2 shows a cross-section of a device for fastening a component to a wall of a fuel tank according to the invention shown in FIG. 1a.

FIG. 3 shows a cross-section of the device for fastening a component to a wall of a fuel tank according to the invention in a second particular embodiment, in which the device for fastening a component to a wall of a fuel tank comprises a triangular anchoring element, partially anchored in the wall of a fuel tank.

FIG. 4 shows a cross-section of the device for fastening a component to a wall of a fuel tank according to the invention in a third particular embodiment, in which said device for fastening a component to a wall of a fuel tank comprises a triangular anchoring element, completely anchored in the wall of a fuel tank.

FIG. 5 shows a cross-section, in a fourth particular embodiment, of the device for fastening a component to a wall of a fuel tank according to the invention, in which the part of the anchoring element comprising the larger dimensions has a protuberance allowing a new melting point of the anchoring element to a wall of a fuel tank.

FIG. 6 depicts a cross-section of the device for fastening a component to a wall of a fuel tank according to the invention in a fifth particular embodiment, in which said device for fastening a component to a wall of a fuel tank comprises a connecting element, comprising a first end defining a first connection means by a triangular core surrounded by an anchoring element.

### DESCRIPTION OF AT LEAST ONE EMBODIMENT OF THE INVENTION

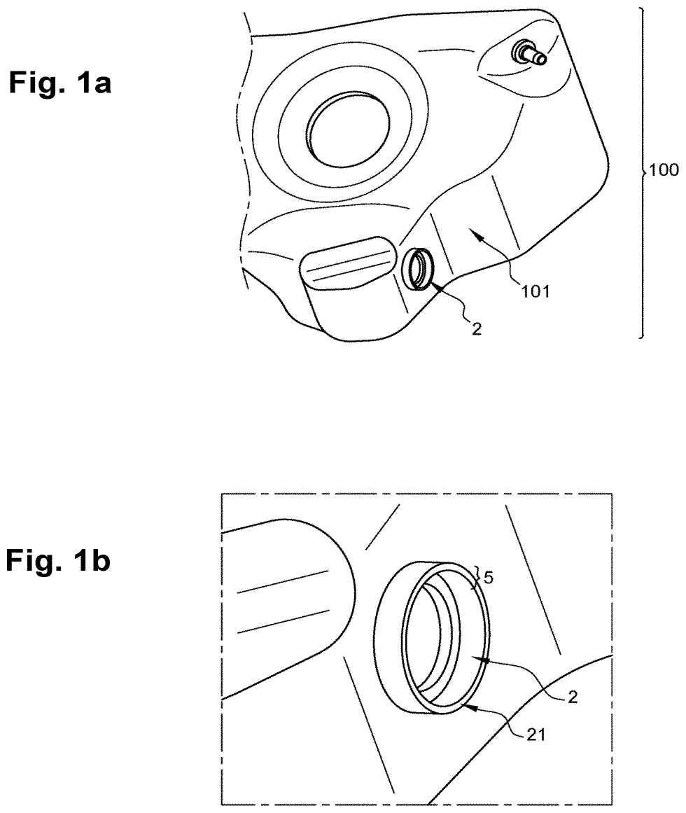

Referring to FIG. 1a, an embodiment of a device for fastening a component to a wall (101) of a fuel tank (100) according to the invention is presented. The device for fastening a component to a wall (101) of a fuel tank (100) comprises a connecting element (2) capable of being connected to a component, said component not being shown in FIG. 1a.

FIG. 1b shows an enlargement of the embodiment of a device (10) for fastening a component to a wall (101) of a fuel tank (100) according to the invention illustrated in FIG. 1a. The device for fastening a component to a wall (101) of a fuel tank (100) comprises a connecting element (2) comprising a second connection means (5) suitable for connecting a component to a second end (21), said component not being shown in FIG. 1b.

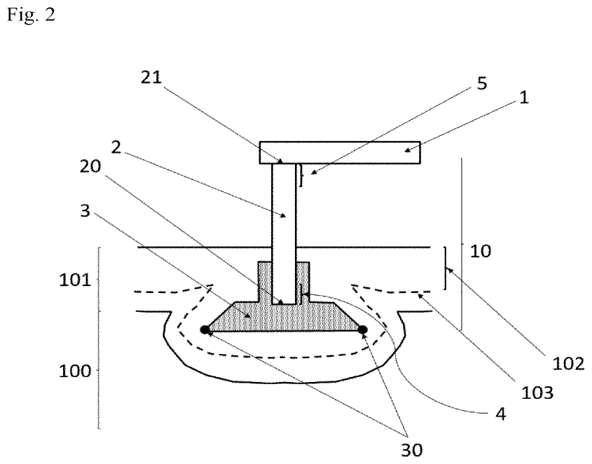

FIG. 2 shows a cross-section of an embodiment of a device (10) for fastening a component (1) to a wall (101) of a fuel tank (100) according to the invention illustrated in FIG. 1. The fastening device (10) comprises an anchoring element (3) suitable for being secured to said wall (101) of the fuel tank (100), as well as a connecting element (2) comprising a first end (20) defining a first connection means (4) to said anchoring element, said connection means (4) being an overmolding by bi-injection. The device (10) for fastening a component (1) to a wall (101) of a fuel tank (100) comprises a second connection means (5) connecting the second end (21) of said connecting element (2) to said component (1), said second connection means (5) being a weld. The device (10) for fastening a component (1) to a wall (101) of a fuel tank (100) also comprises an anchoring element (3) in which said anchoring element (3) has a portion fused (30) to said wall (101) of said tank (100); said portion fused (30) to said wall (101) of said tank (100) is a portion formed by at least one end of a portion of the anchoring element (3) having the largest dimension of said anchoring element (3). In a particular embodiment illustrated in FIG. 2, said anchoring element (3) of said device has two fusion points (30) with said wall (101) of said tank (100). The wall (101) of a fuel tank (100) also has a thickness (102) in that said anchoring element (3) penetrates at least partially into said thickness (102). The anchoring element (3) of the device (10) for fastening a component (1) to a wall of a fuel tank (100) is not in contact with the fuel-impermeable layer (103) of a fuel tank (100).

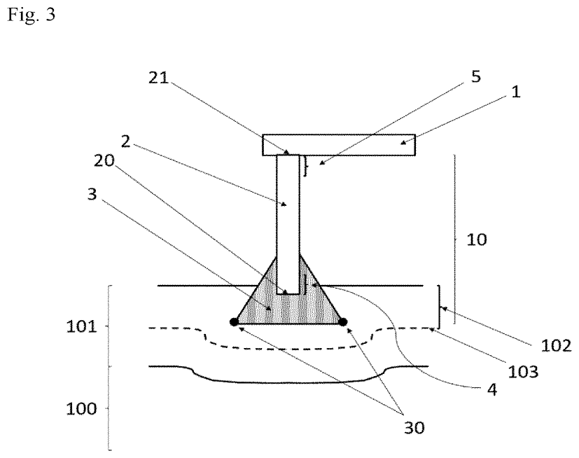

FIG. 3 shows a cross-section of the device (10) for fastening a component (1) to a wall (101) of a fuel tank (100) according to the invention, in a second particular embodiment. It is observed that the device (10) for fastening a component (1) to a wall (101) of a fuel tank (100) comprises an anchoring element (3) suitable for being secured to said wall (101) of the fuel tank (100), as well as a connecting element (2) comprising a first end (20) defining a first connection means (4) to said anchoring element, said connection means (4) being an overmolding by bi-injection. The device (10) for fastening a component (1) to a wall (101) of a fuel tank (100) comprises a second connection means (5) connecting the second end (21) of said connecting element (2) to said component (1), said second connection means (5) being a weld. The device (10) for fastening a component (1) to a wall (101) of a fuel tank (100) also comprises an anchoring element (3) in which said anchoring element (3) has a portion fused (30) to said wall (101) of said tank (100); said portion fused (30) to said wall (101) of said tank (100) is a portion formed by at least one end of a portion of the anchoring element (3) having the largest dimension of said anchoring element (3). In the particular embodiment illustrated in FIG. 3, said anchoring element (3) of said device has two fusion points (30) with said wall (101) of said tank (100). The wall (101) of a fuel tank (100) also has a thickness (102) in that said anchoring element (3) penetrates at least partially into said thickness (102). The anchoring element (3) of the device (10) for fastening a component (1) to a wall of a fuel tank (100) is not in contact with the fuel-impermeable layer (103) of a fuel tank (100). In addition, in this particular embodiment, the anchoring element (3) is triangular in shape. The triangular shape of the anchoring element (3) of the device (10) for fastening a component (1) to a wall (101) of a fuel tank (100) is given by way of simple illustrative and non-limiting example. Indeed, the anchoring element (3) according to the invention can assume inter alia a trapezoidal, spherical, helical, cubic, rectangular or any other regular or irregular geometric shape.

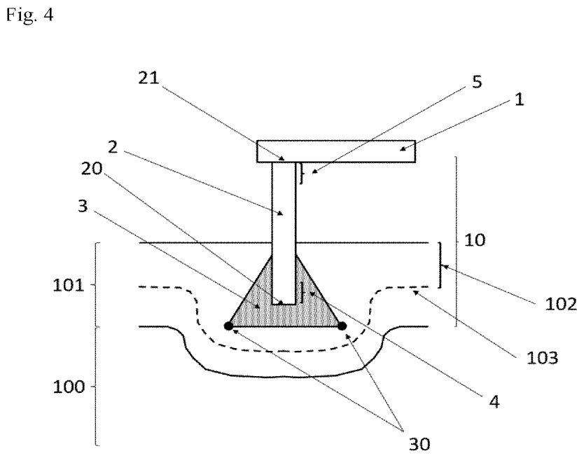

FIG. 4 illustrates a cross-section of the device (10) for fastening a component (1) to a wall (101) of a fuel tank (100) according to the invention, in a third particular embodiment. It is observed that the device (10) for fastening a component (1) to a wall (101) of a fuel tank (100) comprises an anchoring element (3) suitable for being secured to said wall (101) of the fuel tank (100), as well as a connecting element (2) comprising a first end (20) defining a first connection means (4) to said anchoring element, said connection means (4) being an overmolding by bi-injection. The device (10) for fastening a component (1) to a wall (101) of a fuel tank (100) comprises a second connection means (5) connecting the second end (21) of said connecting element (2) to said component (1), said second connection means (5) being a weld. The device (10) for fastening a component (1) to a wall (101) of a fuel tank (100) also comprises an anchoring element (3) in which said anchoring element (3) has a portion fused (30) to said wall (101) of said tank (100); said portion fused (30) to said wall (101) of said tank (100) is a portion formed by at least one end of a portion of the anchoring element (3) having the largest dimension of said anchoring element (3). In the particular embodiment illustrated in FIG. 4, said anchoring element (3) of said device has two fusion points (30) with said wall (101) of said tank (100). The wall (101) of a fuel tank (100) also has a thickness (102) in that said anchoring element (3) penetrates completely into said thickness (102). The anchoring element (3) of the device (10) for fastening a component (1) to a wall of a fuel tank (100) is not in contact with the fuel-impermeable layer (103) of a fuel tank (100). In addition, in this embodiment, the anchoring element (3) is triangular in shape. The triangular shape of the anchoring element (3) of the device (10) for fastening a component (1) to a wall (101) of a fuel tank (100) is given by way of simple illustrative and non-limiting example. Indeed, the anchoring element (3) according to the invention can assume inter alia a trapezoidal, spherical, helical, cubic, rectangular or any other regular or irregular geometric shape.

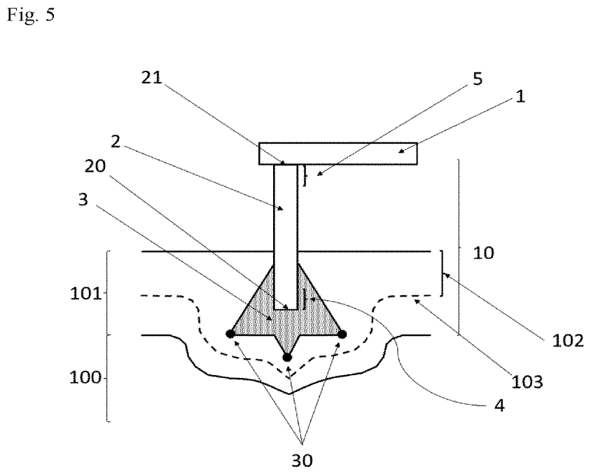

FIG. 5 describes a cross-section of the device (10) for fastening a component (1) to a wall (101) of a fuel tank (100) according to the invention, in a fourth particular embodiment. It is observed that the device (10) for fastening a component (1) to a wall (101) of a fuel tank (100) comprises an anchoring element (3) to be secured to said wall (101) of the fuel tank (100), as well as a connecting element (2) comprising a first end (20) defining a first connection means (4) to said anchoring element, said connection means (4) being an overmolding by bi-injection. The device (10) for fastening a component (1) to a wall (101) of a fuel tank (100) comprises a second connection means (5) connecting the second end (21) of said connecting element (2) to said component (1), said second connection means (5) being a weld. The device (10) for fastening a component (1) to a wall (101) of a fuel tank (100) also comprises an anchoring element (3) in which said anchoring element (3) has a protuberance, in the lower part of said anchoring element (3), oriented toward the wall (102) of a fuel tank (100) allowing a new fusion point (30) of the anchoring element (3) to a wall (101) of a fuel tank (100), as well as an increase in the fuel leakage path reinforcing the low permeability of the assembly. The assembly is made up of the device (10) for fastening a component (1) to a wall (101) of a fuel tank (100) and a fuel tank (100) comprising said device (10) for fastening a component (1). The device (10) for fastening a component (1) to a wall (101) of a fuel tank (100) also comprises an anchoring element (3) in which said anchoring element (3) has a portion fused (30) to said wall (101) of said tank (100); said portion fused (30) to said wall (101) of said tank (100) is a portion formed by at least one end of a portion of the anchoring element (3) having the largest dimension of said anchoring element (3). In the particular embodiment illustrated in FIG. 5, said anchoring element (3) of said device has three fusion points (30) with said wall (101) of said tank (100). The wall (101) of a fuel tank (100) also has a thickness (102) in that said anchoring element (3) penetrates completely into said thickness (102). The anchoring element (3) of the device (10) for fastening a component (1) to a wall of a fuel tank (100) is not in contact with the fuel-impermeable layer (103) of a fuel tank (100). In addition, in this embodiment, the anchoring element (3) is triangular in shape. The triangular shape of the anchoring element (3) of the device (10) for fastening a component (1) to a wall (101) of a fuel tank (100) is given by way of simple illustrative and non-limiting example. Indeed, the anchoring element (3) according to the invention can assume inter alia a trapezoidal, spherical, helical, cubic, rectangular or any other regular or irregular geometric shape.

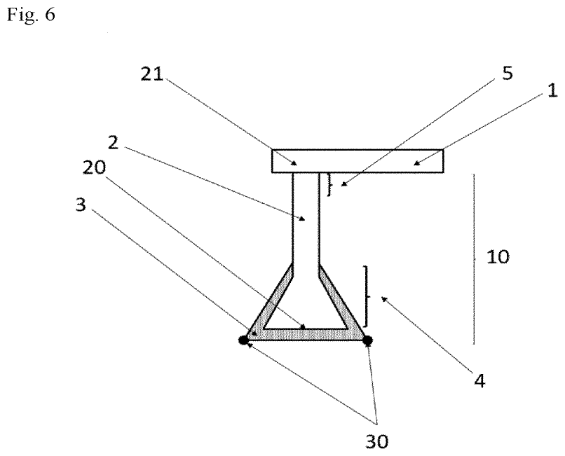

FIG. 6 shows another embodiment of the fastening device by a cross-section of the device (10) for fastening a component (1) according to the invention, in a fifth particular embodiment. It is observed that the device (10) for fastening a component (1) comprises an anchoring element (3), as well as a connecting element (2) comprising a first end (20) defining a first connection means (4) to said anchoring element, said connection means (4) being an overmolding by bi-injection. The device (10) for fastening a component (1) also comprises an anchoring element (3) in which said anchoring element (3) has a suitable for being fused portion (30); said portion suitable for being fused (30) is a portion formed by at least one end of a portion of the anchoring element (3) having the largest dimension of said anchoring element (3). In the particular embodiment illustrated in FIG. 6, said anchoring element (3) of said device has two fusion points (30). In addition, in this embodiment, the device (10) for fastening a component (1) comprises a connecting element (2) comprising a first end (20) defining a first connection means (4) by a triangular core surrounded by an anchoring element (3). The triangular shapes of the anchoring element (3) and of the first connection means (4) of the device (10) for fastening a component (1) are given by way of simple illustrative and non-limiting example; the anchoring element (3) and the first connection means (4) according to the invention can assume inter alia a trapezoidal, spherical, helical, cubic, rectangular or any other regular or irregular geometric shape.

1. A device for fastening a component to a wall of a fuel tank having a thickness, comprising:
an anchoring element suitable for being secured to said wall of the fuel tank and for penetrating at least partially into said thickness,
a connecting element comprising a first end and a second end,
a first connection means for connecting said first end to said anchoring element, and
a second connection means for connecting said second end to said component.

2. The device for fastening a component to a wall of a fuel tank according to claim 1, wherein said anchoring element is a square, polygonal, rectangular or cylindrical ring.

3. A device for fastening a component to a wall of a fuel tank according to claim 1, wherein said first connection means is selected from the group consisting of a hoop, a rivet, a thread, a screw, a clip, a dovetail assembly, a straight shank assembly, a relief assembly, and a undercut assembly.

4. A device for fastening a component to a wall of a fuel tank according to claim 1, wherein said second connection means is selected from the group consisting of a hoop, a rivet, a thread, a screw, a clip, a dovetail assembly, a straight shank assembly, a relief assembly, and a undercut assembly.

5. A device for fastening a component to a wall of a fuel tank according to claim 1, wherein said anchoring element comprises a plastic material, wherein said plastic material comprises a polyolefin base.

6. A device for fastening a component to a wall of a fuel tank according to claim 1, wherein said connecting element comprises a plastic material, said plastic material based on a material selected from the group consisting of polyoxymethylene, polyphenylene sulfide, polyamide, polyphthalamide, polyetheretherketone, polyamide imide, polyaryletherketone, polyketone and polyolefin.

7. A device for fastening a component to a wall of a fuel tank according to claim 1, wherein said anchoring element comprises a part capable of being fused to said wall of said fuel tank.

8. A device for fastening a component to a wall of a fuel tank according to claim 1, wherein said wall of said fuel tank has a fuel-impermeable layer and wherein said interface element is not in contact with said layer.

9. A fuel tank comprising a device for fastening a component to a wall of a fuel tank according to claim 1.

10. The fuel tank according to the claim 9, wherein the anchoring element is secured to said wall of the fuel tank without passing through it.

11. The fuel tank according to claim 9, wherein said wall of the fuel tank comprises a layer made of a polyolefin-based material into which the anchoring element penetrates.

12. A method of manufacturing a fuel tank comprising a device according to claim 1, the method comprising at least the following steps:
Providing a wall of a fuel tank having a thickness;
Securing said anchoring element to said wall by causing it to penetrate at least partially into said thickness.

13. A device for fastening a component to a wall of a fuel tank according to claim 1, wherein said first connection means is selected from the group consisting of a weld, a glue, a mechanical assembly with a seal, and an overmold.

14. A device for fastening a component to a wall of a fuel tank according to claim 1, wherein said first connection means is an overmolding.

15. A device for fastening a component to a wall of a fuel tank according to claim 1, wherein said first connection means is an overmolding by bi-injection.

16. A device for fastening a component to a wall of a fuel tank according to claim 1, wherein said second connection means is selected from the group consisting of a weld, a glue, a mechanical assembly with a seal, and an overmold.

17. A device for fastening a component to a wall of a fuel tank according to claim 1, wherein said second connection means is a weld.

18. A device for fastening a component to a wall of a fuel tank according to claim 1, wherein said anchoring element comprises a plastic material, wherein said plastic material is polyethylene.

19. A device for fastening a component to a wall of a fuel tank according to claim 1, wherein said anchoring element comprises a plastic material, wherein said plastic material is maleic anhydride grafted polyethylene.
